(19) United States
(12) Patent Application Publication
(10) Pub. No.: US 2025/0269997 A1
(43) Pub. Date: Aug. 28, 2025

(54) High Speed Labelling of Objects

(71) Applicant: ATS Corporation, Cambridge (CA)

(72) Inventors: Marty Juritsch, Cambridge (CA); Roger Hogan, Cambridge (CA); Stephen Fisher Aikens, Cambridge (CA)

(21) Appl. No.: 19/066,698

(22) Filed: Feb. 28, 2025

Related U.S. Application Data
(60) Provisional application No. 63/559,029, filed on Feb. 28, 2024.

(51) Int. Cl. B65C 9/04; B65C 9/30; B65C 9/34

(52) U.S. Cl. CPC B65C 9/04; B65C 9/30; B65C 9/34

(57) ABSTRACT

A label can be applied to an object having an asymmetric cross section that is held on a moving shuttle of a linear motor conveyor. The label is first flagged to the object by affixing a first portion of the label to the object. The label is wrapped on to the object by an applicator by rotating the object by a motor on the shuttle. The applicator moves along with the shuttle, at least in an application zone and approximately matches the speed of the shuttle, or the speed of the shuttle and the tangential surface speed of the rotating object.

### RELATED APPLICATIONS

The current disclosure claims priority to U.S. Provisional Application 63/559,029 entitled High Speed Labelling of Objects and filed Feb. 28, 2024, the entire contents of which are incorporated herein by reference for all purposes.

### TECHNICAL FIELD

The current disclosure relates to systems and methods of applying a label to an object and in particular to the high-speed labelling of objects.

### BACKGROUND

The automatic labelling of objects in the pharmaceutical environment can be used to affix important information to the object such as usage instructions, warnings, etc. The object having the label applied in various ways, however, generally all involve wrapping the label on the object. It can be difficult to provide reliable labelling of objects at high speed. For example, while it may be relatively easy to apply labels to, for example, ten objects per minute, it can be significantly more difficult to increase the labelling speed to handle labeling hundreds of objects a minute.

An additional, alternative and/or improved labelling system is desirable for the high speed application of labels to objects.

### BRIEF DESCRIPTION OF THE DRAWINGS

Further features and advantages of the present disclosure will become apparent from the following detailed description, taken in combination with the appended drawings, in which:

FIGS. 1A-1C depict a schematic of an object that may have a label affixed thereto;

FIG. 2 depicts a high speed labelling system;

FIGS. 3A-3C depict a schematic of details of a high speed labelling system;

FIGS. 4A, 4B depict a schematic of details of a high speed labelling system;

FIGS. 5A, 5B depict a schematic of details of a high speed labelling system;

FIGS. 6A, 6B depict a schematic of details of a high speed labelling system;

FIGS. 7A, 7B depict a schematic of details of a high speed labelling system;

FIGS. 8A-8C depict a schematic of details of a high speed labelling system;

FIGS. 9A-9C depict a schematic of details of a high speed labelling system;

FIGS. 10 and 11 depict a schematic of a mechanical rotation mechanism; and

FIGS. 12 and 13 depict operation of the mechanical rotation mechanism.

### DETAILED DESCRIPTION

In accordance with the present disclosure there is provided system for applying a label to an object, the system comprising: a conveyor system comprising a shuttle controllably moveable along a track, the shuttle comprising: a mount for holding an object to have the label applied to, the object having a longitudinal axis; and a rotation mechanism for rotating the object around the longitudinal axis; a label dispenser arranged adjacent the track in order to affix a first portion of a label dispensed onto the object on the shuttle; and an applicator arranged opposite a surface of the object having the label affixed to, the applicator contacting the label as the object is rotated in order to affix the label to the surface of the object.

In a further embodiment of the system, the applicator is moveable to match a speed of the shuttle or a speed of the object at a contact location between the object and the applicator.

In a further embodiment of the system, the object has an asymmetric cross-section about the longitudinal axis.

In a further embodiment of the system, the applicator comprises a tamping pad that is mounted to an actuator that moves the tamping pad parallel to the shuttle and matching the shuttle speed while contacting the label being applied to object in an application zone.

In a further embodiment of the system, the applicator comprises a rotating belt.

In a further embodiment of the system, the rotating belt is mounted to an actuator that moves the rotating belt parallel to the shuttle matching a shuttle speed while contacting the label being applied to object in an application zone.

In a further embodiment of the system, the rotating belt rotates at a speed to account for the rotation of the object.

In a further embodiment of the system, the belt rotates at a speed to account for the shuttle speed and rotation of the object.

In a further embodiment of the system, the actuator can be moved towards and away from the surface of the object to account for the asymmetric cross-section of the object as it is rotated.

In a further embodiment of the system, a speed of the rotating belt is adjustable.

In a further embodiment of the system, the shuttle holds a plurality of objects.

In a further embodiment of the system, a spacing between objects on the shuttle allows respective objects to rotate a sufficient amount such that a surface of a subsequent object to contact the rotating belt is an equal distance from the rotating belt as a surface of the preceding object.

In a further embodiment of the system, the applicator is mounted on the shuttle.

In a further embodiment of the system, the applicator is moveable to allow loading and unloading of the object to be labelled from the mount.

In a further embodiment of the system, the applicator is provided as a roller.

In a further embodiment of the system, the rotation mechanism comprises: a motor for rotating the object around the longitudinal axis; and a power source for operating the motor;

In a further embodiment of the system, the mount holds a plurality of objects to be labeled.

In a further embodiment of the system, the system further comprises a plurality of motors, each for rotating a respective one of the plurality of objects.

In a further embodiment of the system, the system further comprises a drive train for rotating the plurality of objects with the motor.

In a further embodiment of the system, the rotation mechanism comprises a mechanical rotation mechanism.

In a further embodiment of the system, the mechanical rotation mechanism comprises: a movable support coupled to the shuttle, the movable support comprising: a bearing secured to the moveable support in a fixed relative position; and a screw and nut arranged to translate relative linear movement between the screw and nut into rotational movement of the mount, wherein the system further comprises: a cam plate having a profile that the bearing contacts and causes relative linear movement between the screw and nut as the shuttle moves along the track.

In a further embodiment of the system, the screw is rotationally fixed to the moveable support and the nut is free to rotate.

A high speed labelling system, which may be able to apply the labels to hundreds of objects a minute is described further below. The labelling system can apply labels to objects that may not have a symmetric cross-section. The objects may be a wide range of objects with varying cross-sectional sizes. For example, the objects may be injector pens for pharmaceutical compositions, vials, syringes, bottles, canisters etc. The objects can be loaded onto a shuttle of a linear motor conveyor system. The shuttle has a rotation mechanism for rotating the objects on the shuttle as the label is applied. The rotation mechanism may be able to rotate the objects in multiple directions and/or at varying speeds.

When labelling an object, the labels are first flagged to the objects by affixing an edge of the label to the object. Once the label is initially attached to the object, the rotation mechanism on the shuttle is then operated in order to rotate the object, and the attached label. The rotation of the object causes the label to be affixed to the object by an applicator that presses the label to the object. In order to provide the high throughput, the labels can be applied as the shuttle is moving along the linear motor conveyor. In order to reliably apply the labels, the applicator approximately matches the speed of the object as it moves. The applicator may move with the shuttle as the label is applied, or it may be a conveyor belt style applicator with the belt speed approximately matching the surface speed of the object.

The labelling system can advantageously apply labels at high speed while the objects are held on a shuttle travelling on the linear motor conveyor system. In addition to the high throughput of the labelling system, by applying the labels while the object is on the shuttle of the linear motor conveyor system, the objects may not need to be loaded to and from the shuttle system as frequently, which can increase the overall throughput of the system as well as reducing the complexity of the overall system. The labelling system described further below can achieve the high throughput even when labelling objects that have an asymmetric cross-section about the axis of rotation. That is, the labelling system can achieve the high throughput even if the objects do not have a circular cross-section. The high throughput of the labelling system may be in the range of 100 objects per minute, 500 objects per minute or more.

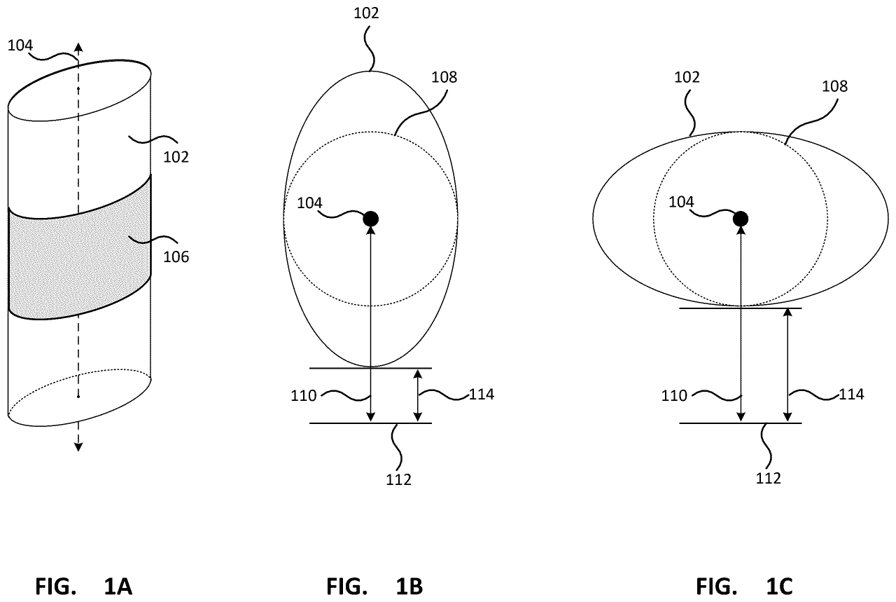

FIGS. 1A-1C depict a schematic of an object that may have a label affixed thereto. An object is depicted in FIG. 1A. As depicted, the object 102 may have an elongated shape along a longitudinal axis 104. A label 106 can be affixed to an outer surface of the object 102. Although the object 102 is depicted as a having a constant profile along its longitudinal axis, it may have a varying profile. The label 106 may be affixed to a specific location on the object and may wrap around only a portion of the object or may wrap around substantially all of the object. The positioning of the label may be controlled so that the label starts at the same location of the object across all objects being labelled.

The object 102 may have an asymmetric cross-section about the longitudinal axis. As most clearly depicted in FIGS. 1B, 1C the cross-section profile of the object 102 is depicted as an ellipse. A symmetric cross-section profile is depicted in FIGS. 1B and 1C as circle 108 shown in stippled line. If the angular velocity of the object is constant as it rotates about its longitudinal axis, a tangential speed of the surface of the object at a point adjacent the stationary surface 112 will vary. As is clear from comparing FIGS. 1B and 1C, in addition to the changing surface speed, with a distance 110 between the longitudinal axis 104 and a fixed location 112 held constant as the object rotates about the longitudinal axis 104, a distance 114 between an outer surface of the object and the fixed location will vary as a result of the asymmetric cross-section.

In order to apply the label 106 to the surface of the object 102, the labeled is first ‘flagged’ to the object by affixing one end of the label to the object. The object is then rotated about its longitudinal axis while an applicator presses the label onto the surface of the object. As described further below, in order to provide a high throughput labelling system, the object may have the label applied to it while it is held be a shuttle travelling on a linear motor conveyor. The shuttle includes a motor, or actuator, capable of rotating the object about its longitudinal axis. Once the label is flagged or initially affixed to the object, the object can be rotated on the shuttle while the shuttle moves on the conveyor. An applicator contacts the object, or more particularly the label on top of the object, and presses the label onto the object. If the leading edge of the label is not adhered sufficiently to the object in the initial application, affixing of the remaining portion of the label may fail, either partially or completely. The object may be rotated at a lower speed relative to the applicator, and possibly in multiple directions back and forth in order to further press the leading edge of the label onto the object. By slowly rotating the object, the leading edge of the label may be more securely attached to the object. Once the leading edge of the label is affixed to the object, the object may be rotated against the applicator in order to wrap the remainder of the label on the object.

The applicator may move with the object as it rotates and moves on the conveyor. If the applicator were stationary, the forces on the label could lead to undesirable outcomes. That is, as a result of the high throughput of the labelling system, it could be possible to rip, tear, mar, scuff, etc. the label as a result of the high relative velocities between the label and the applicator.

The applicator can move in order reduce the relative velocities between the labels and applicator, even in high throughput applications where the object move relatively quickly on the conveyor and also rotate relatively quickly on the shuttle. As described further below, it may be possible to substantially match speed of the applicator to the tangential surface speed of the object where it contacts the applicator, which can reduce forces on the label could produce undesirable results.

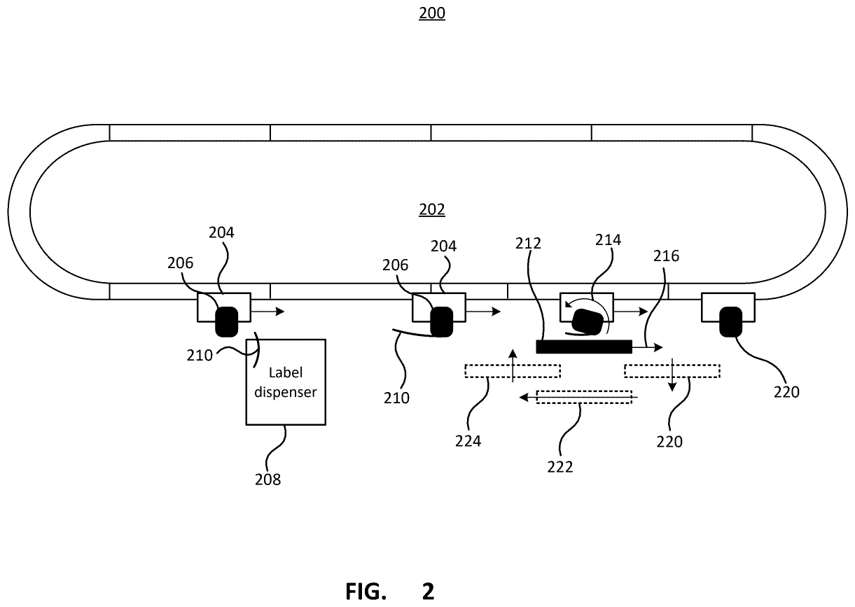

FIG. 2 depicts a high speed labelling system. The system 200 is depicted as comprising a linear motor conveyor 202. The conveyor 202 is depicted as an oval loop formed from a plurality of straight track sections and curved track sections. It will be appreciated that although depicted as a loop, the conveyor 202 may have a wide range of shapes and orientations. The conveyor 202 comprises a plurality of electromagnetic coils that can be controlled in order to provide a motive force to a shuttle 204. The conveyor system can control the electromagnetic coils in order to precisely control the motion of the shuttle 204. It will be appreciated that a plurality of shuttles can be arranged on the linear motor conveyor 202 and their movement on the track can be individually controlled. It is noted that the schematic of FIG. 2 only shows a labelling system as operating along the conveyor. It will be appreciated that additional processing steps may be performed before and after the labelling processes without having to load and or unload the objects from the conveyor system.

An object 206 that is to have a label applied to it can be held on the moving shuttle 204 by a mount as it moves along the track. In addition to holding the object 206, the shuttle includes a motor that can rotate the object about its longitudinal axis. The shuttle may include a power source for the motor, which could be provided using a wireless power transfer system (not shown) and/or one or more batteries (not shown). The shuttle moves along the track through a labelling section.

The labelling section of the conveyor comprises a label dispenser 208 that can dispense individual labels 210 on to the objects as they pass. The label dispenser 208 is arranged to flag an individual label onto the object by affix, for example by pressing or otherwise contacting, an edge of the label to the object. The object can be oriented, for example by operating the motor, such that the label is initially attached to the object at the same location on every object. Such flexibility allows the precise location of the label to be controlled. While such control may not be important if the object has a substantially symmetric cross-section, it can be important, or at least desirable, to control the position on the object where the label is first affixed, when the object has an asymmetric cross-section.

The shuttle 204, with the object and the flagged label travels along the conveyor system to an application zone in which an applicator 212 presses the label onto the object as the object rotates 214 about its longitudinal axis. As described further below, the applicator may be provided in various ways including as a tamping pad, rotating belt, or roller that contacts the label and object. The applicator 212 may move along with the shuttle as depicted by arrow 216. The movement of the applicator 212 to match the shuttle movement can significantly reduce the relative velocities between the label being applied and the applicator. Once the label is fully applied to the object, the shuttle and the labelled object 220 can be further processed. It will be appreciated that processing of the labelled object may take a wide range of actions including for example, inspecting the object and/or labelling, packaging the object, and/or performing other manufacturing and/or assembly operations.

Once the label is applied to the object, the rotation of the object may stop, unless it is desirable for subsequent actions, and the applicator may return to a starting position, for example by detaching from, or moving away from the object as depicted by arrow 20, returning towards an initial contact location as depicted by arrow 222 and then moving towards a subsequent object to contact the object and label as depicted by arrow 224.

Although the above has described a single object being mounted to a respective moving shuttle, it is possible to mount multiple objects to a single shuttle. When multiple objects are mounted on a single shuttle, all of the objects may be simultaneously rotated using a single motor and gears or similar drive train, or the objects may be individually rotated by respective motors which may be individually controlled.

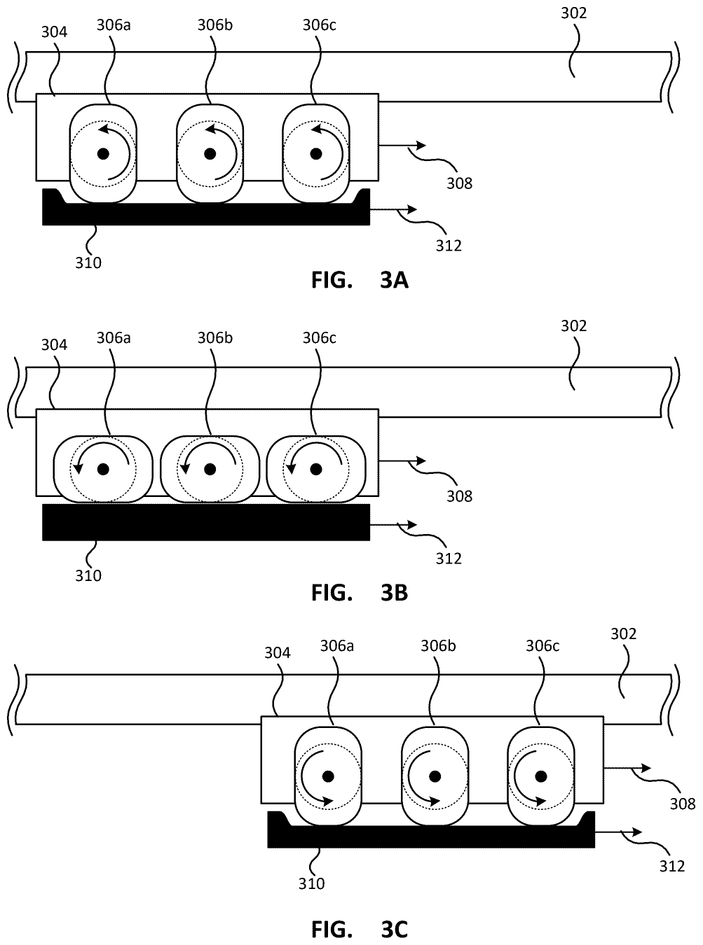

FIGS. 3A-3C depict a schematic of details of a high speed labelling system. The system depicted in FIGS. 3A-3C uses a moving applicator, depicted as a compliant tamping pad to press individual labels onto the objects. As depicted in the FIGS. a moving shuttle 304 moves along a track 302. A plurality of objects are held on the shuttle by respective mounts. The objects and mounts may have corresponding features that allow the object to be keyed to the mount and secure the object for rotation. If the object does not include suitable features for keying the object to the mount, the object can be held by the mount in other ways such as using a vacuum or gripper. Regardless of how the objects are secured in the mount, the asymmetric cross-section of the objects should be aligned along with the rotation of the objects so that the distance between the object and the applicator is the same, or substantially similar, for all of the objects. This keyed rotation of the objects is depicted in FIGS. 3A-3C.

Three objects 306a, 306b, 306c (referred to collectively as objects 306) are depicted as being mounted to the shuttle 304. It is assumed that the label has been affixed to each of the objects and the shuttle moves along the track section depicted by arrow 308. The applicator 310 is depicted as a compliant member that provides sufficient elasticity or deformation to allow the applicator to maintain contact with the object regardless of the rotational orientation of the object. For example, as depicted in FIGS. 3A and 3C profile of the object causes the applicator to be compressed. As depicted in FIG. 3B, as the objects 306 rotate, the applicator may expand in order to maintain contact with the object and label. Although the applicator 310 is depicted as a compliant material that can compress and expand to maintain contact, the applicator may take other forms such as an elastic web or similar structure that can maintain the contact as the objects rotate. The applicator 310 moves with the motion of the shuttle on the track as depicted by arrow 312. With the applicator moving along with the shuttle, the relative velocity between the labels being applied and the applicator will only be a result of the rotation of the object and as such reduced forces may be applied to the label and object.

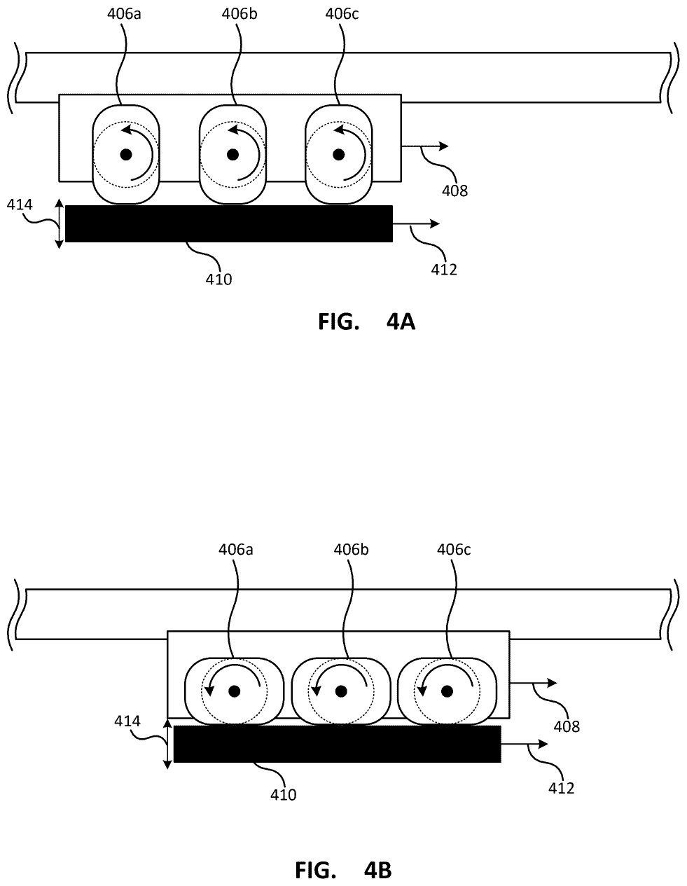

FIGS. 4A, 4B depict a schematic of details of a high speed labelling system. The system depicted in FIGS. 4A and 4B is substantially similar to that of FIGS. 3A-3C. However, rather than using a compliant applicator as described above, the applicator may move towards and away from the objects as depicted by arrow 414 in order to account for the asymmetric cross-section of the object. The applicator 410 may move with the shuttle as depicted by arrows 408 and 412. As the objects rotate the distance between the longitudinal axis and the outer surface adjacent the applicator changes. In order to account for the changing distance, the applicator 410 can move, by way of an actuator (not shown), towards and away from the object to maintain a constant, or approximately constant, contact force on the label from the applicator.

The applicator described above with reference to FIGS. 3A-3C and 4A-4B is a tamp pad or similar structure and can only account for the motion of the shuttle and not the motion of the label resulting from the object's rotation. As described further below, the applicator may be provided as a rotating belt, which can account for both the movement of the shuttle and the motion of the label resulting from the object's rotation.

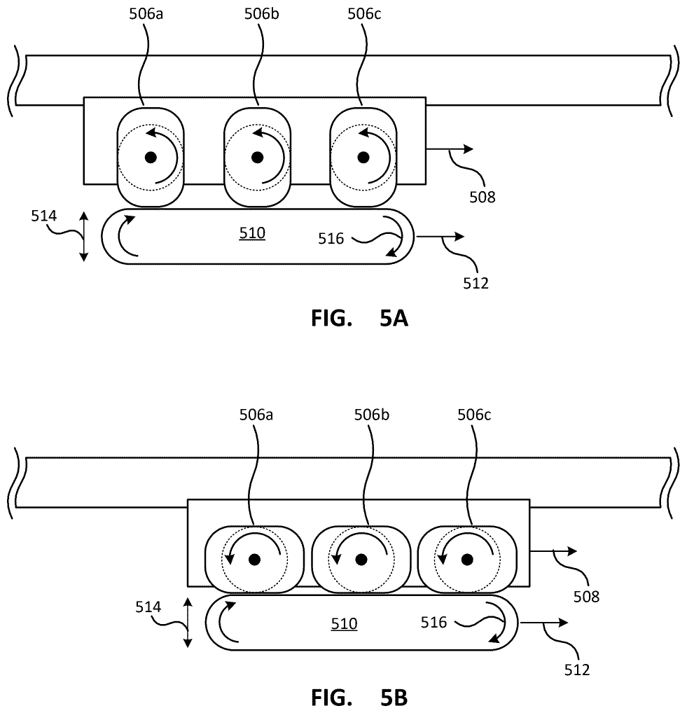

FIGS. 5A, 5B depict a schematic of details of a high speed labelling system. The system depicted in FIGS. 5A and 5B is similar to that described above with reference to FIGS. 4A and 4B. The applicator 510, which is a rotating belt, can move with the movement of the shuttle as depicted by arrows 508 and 510. In addition to the translation with the shuttle, the rotating belt can also rotate as depicted by arrow 516 in order to account for the movement of the label resulting from the rotation of the objects 506a, 506b, 506c. The rotational speed of the rotating belt 510 may be varied as the tangential speed varies based on the portion of the asymmetric cross-section of the object that is in contact with the belt. The combined rotation of the belt 510 and the translation of the belt can significant eliminate the relative motion between the label and the rotating belt.

The rotating belt 510 of FIGS. 5A and 5B can significantly account for, and eliminate both the translational motion of the object from the shuttle movement as well as the movement of the label resulting from the rotation of the objects. In addition to accounting for the movement, the rotating belt can also be moved towards and away from the objects as depicted by arrow 514. The movement towards/away from the objects can maintain a force applied to the label and object by the belt even as distance between the rotation point of the object and the contact point with the belt changes.

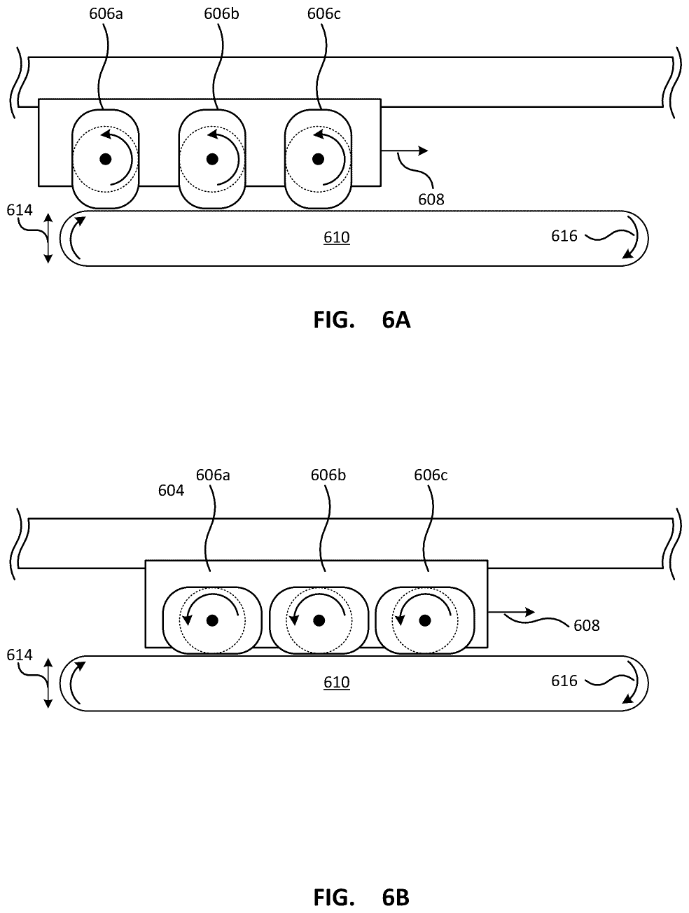

FIGS. 6A, 6B depict a schematic of details of a high speed labelling system. The system depicted in FIGS. 6A and 6B is similar to that described above with reference to FIGS. 5A and 5B; however the rotating belt 610 does not translate with the shuttle motion 608. Rather the rotation speed of the rotating belt 610 is adjusted to account for both the translation of the shuttle, and the motion of the label resulting from the rotation of the object. The rotating belt 610 is elongated relative to the moving belt of FIGS. 5A and 5B so that contact with the belt 610 is maintained as the shuttle moves. The rotating belt 610 may be moved towards and away from the objects to maintain an approximately constant force on the labels and objects as the objects rotate.

Although the above has describe the rotating belts as being able to move towards and away from the objects, it will be appreciated that the belt may has sufficient flexibility or elasticity to maintain contact between the belt and the labels and objects as the objects are rotated. Although such an embodiment may not maintain a substantially constant force on the labels and objects the variance in the force may be acceptably low.

The above has described the movement of the applicator in order to maintain a substantially constant force on the labels and objects. However, it is the relative distance between the axis of rotation and the applicator that is varied to account for the asymmetric cross-section of the object. It will be appreciated that this distance may be varied by moving the applicator as described above, or the axis of rotation as depicted below, or a combination of the two.

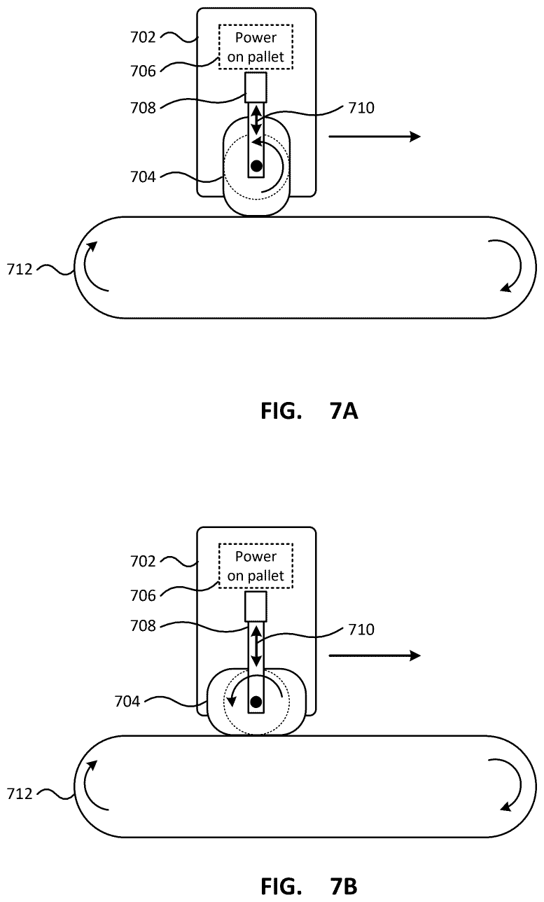

FIGS. 7A, 7B depict a schematic of details of a high speed labelling system. As depicted a shuttle 702 may move along a linear track (not shown). The shuttle includes one or more mounts for holding an object 704 that is having a label applied to it, with a single object being shown in FIGS. 7A and 7B. The shuttle includes a power on shuttle source 706 that provides power to one or more motors or actuators on the shuttle that can controllably rotate the objects on the shuttle. In addition to the rotational motor (not shown), the shuttle may also include an actuator 708 for adjusting the distance of the axis of rotation to the applicator as depicted by arrow 710. The rotating of the rotating belt 712 may account for both the translation of the shuttle and rotation of the object as described above with reference to FIGS. 6A and 6B. Additionally or alternative, the rotating belt may account for only the rotation of the object with the rotating belt moving along with the shuttle similar to the system described above with reference to FIGS. 5A and 5B to account for the translation of the shuttle.

The above has depicted various labelling systems in which the a rotating object, with a label at least partially attached thereto, is brought into contact with an applicator that is arranged separate from the shuttle. It is possible for the applicator to be mounted to the shuttle. With the applicator mounted to the shuttle, it will move with the shuttle and as such there is no resulting relative movement.

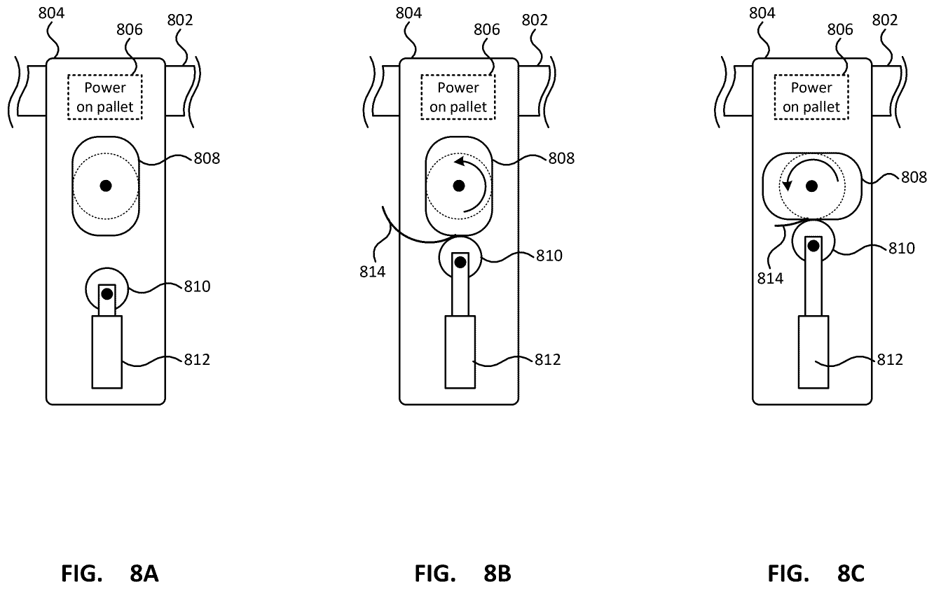

FIGS. 8A-8C depict a schematic of details of a high speed labelling system. As depicted in FIGS. 8A-8C a track section 802 of the linear motor conveyor can have a plurality of shuttles 804 moving on it, with one depicted in FIGS. 8A-8C. The shuttle 804 may include a power on shuttle source 806 capable of providing power to components on the shuttle, including a motor or actuator for rotating an object or objects mounted to the shuttle. Rather than providing an applicator separate from the shuttle as described above, the FIGS. 8A-8C use an applicator mounted on the shuttle itself to contact the label and the object. In order to allow the objects to be mounted into the shuttle, the applicator 810 may be retractable by an actuator 812. The actuator may be operated using the power on shuttle source, or may by operated in a mechanical manner. Regardless, the applicator 810 may be retracted as depicted in FIG. 8A in order to allow the object, or objects, to be mounted to the shuttle in the rotating mount. The applicator may contact the object and a label affixed to the object, either before or after the applicator is applied to the object. The object can be rotated as the shuttle moves along the track. The applicator may be moved towards and away from the object by the actuator in order to account for the asymmetric cross-section and apply a constant force to the label 814 and the object. When the labelled object is being removed from the shuttle, the applicator may again be retracted as depicted in FIG. 8A. The applicator may be a solid roller as depicted in FIGS. 8A.-8C and the roller moved to adjust to the cross-section profile of the object.

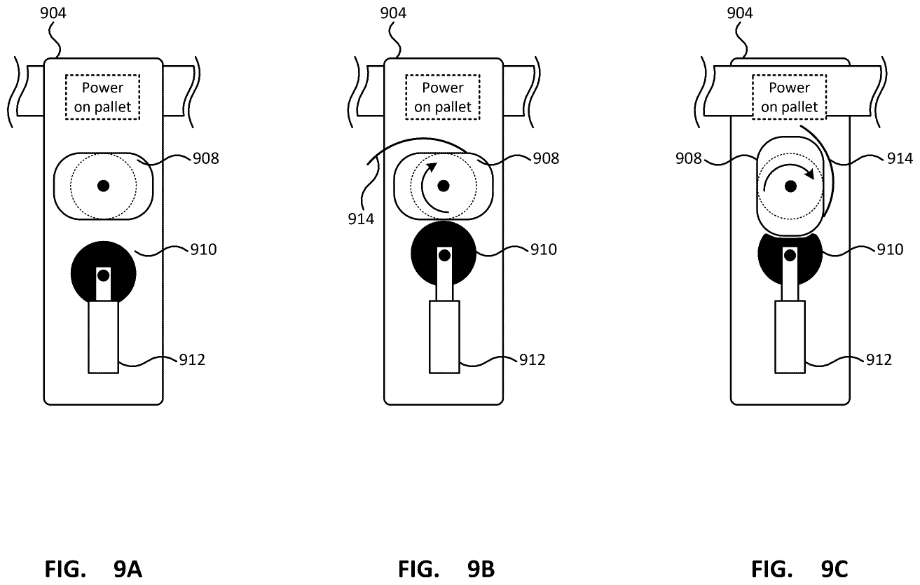

FIGS. 9A-9C depict a schematic of details of a high speed labelling system. The system of FIGS. 9A-9C is substantially similar to that depicted in FIGS. 8A-8C, however, rather than providing a solid applicator that moves with the rotating object's cross-section, the applicator 910 is depicted as a compliant roller that can expand and contract/compress to account for the changing profile. Although the compliant roller 910 does not need to move towards/away from the object to account for the rotating profile, an actuator 912 is still provided in order to retract the applicator when an object 908 is being loaded and/or unloaded from the shuttle 904.

The above has described mounting an object, or objects to a shuttle. The mounting may be provided in various ways including using a chuck, a holding having a shape corresponding to at least a portion of the object, a vacuum, a gripper or other means. Regardless of how the object, or objects are mounted to the shuttle, they are able to rotate about their longitudinal axis. The objects may be mounted with their longitudinal axis arranged vertically or horizontally or at some other angle. When multiple objects are mounted on a single shuttle, a single motor may be used in order to rotate all of the objects. For example the objects, or more particularly the mounts holding the objects, can be coupled to a common motor by way of a drive train. Alternatively, separate motors may be provided for the different objects.

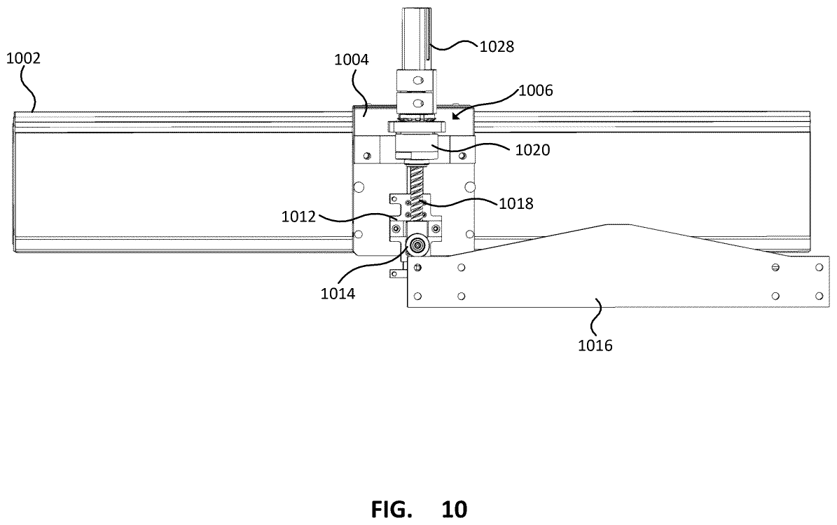

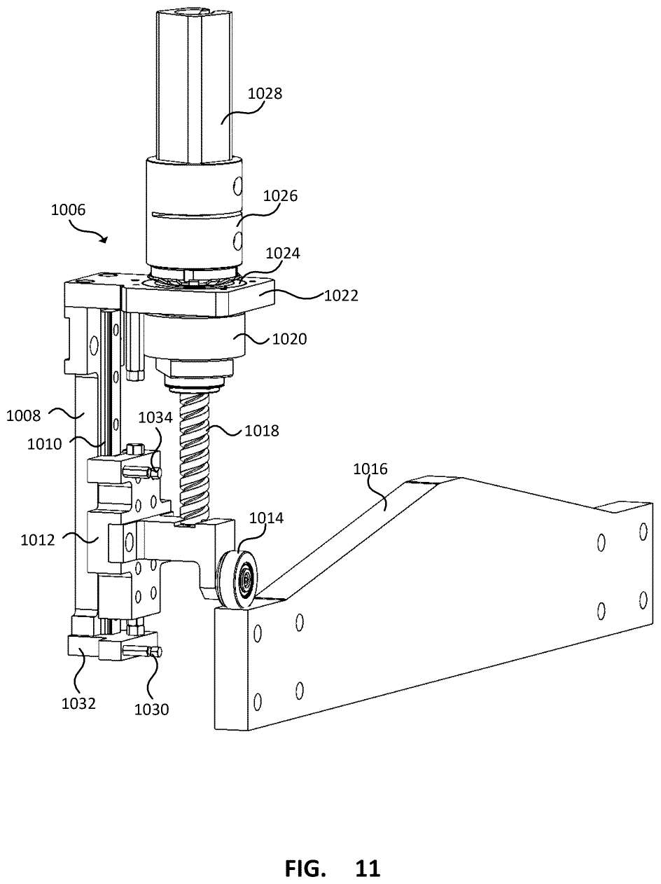

The above has described various ways of rotating the object while the label is being applied, including for example using a motor on the shuttle. As described further below with reference to FIGS. 10 and 11, the objects may be rotated on the shuttle using a purely mechanical mechanism, which may be desirable in one or more different applications.

FIGS. 10 and 11 depict a schematic of a mechanical rotation mechanism. FIG. 10 depicts a section of track 1002 of a linear motor conveyor system. A shuttle 1004 is located on the track and can be controllably moved along the track by a linear motor. Although the track and shuttle are described as part of a linear motor conveyor system, other types of conveyor systems may be sued. The shuttle 1004 has a mechanical rotation mechanism 1006 secured to the shuttle. Details of the mechanical rotation mechanism 1006 are depicted in FIG. 11. The mechanical rotation mechanism 1006 allows a part to be held on the shuttle and caused to rotated in a controlled manner.

As can be seen in FIG. 11, the mechanical rotation mechanism 1006 comprises a frame 1008 that can be mounted to the shuttle 1004. The frame 1008 may be omitted and the components of the mechanical rotation mechanism 1006 mounted directly to the shuttle 1004. A linear rail 1010, or bearing, is mounted to the frame and allows a moving support 1012 to travel vertically on the frame. Although depicted as a linear rail, the moving support 1012 can be moveably coupled to the frame 1008 in a manner that restricts the movement to linear movement along a single axis using other mechanisms. The moveable support 1012 includes a bearing 1014 that bears against a cam plate 1016. The bearing 1014 is depicted as a roller bearing although other types of bearings may be used. The cam plate is arranged along the track at the labelling location where the object being labelled should be rotated. As the shuttle 1004 moves along the track, the bearing 1014 contacts the cam plate 1016, which is profiled in order to cause the bearing, and the moveable support 1012 to rise, and fall. A lead screw 1018 is mounted to the moveable support 1012 and passes through a rotating nut 1020. The rotating nut is fixed in position by an upper support 1022 extending away from the frame 1008. Although the rotating nut is fixed in position it is free to rotate. The rotating nut, or an extension rotationally secured to the rotating nut, passes through the upper support and through one or more bearings 1024 within the upper support. A coupler 1026 can be secured to the rotating nut, or the extension, above the upper support. The coupler can couple the rotating nut, or the extension, to a part holder 1028 that allows the part being labelled to be held securely on the shuttle.

As the shuttle moves along the track, the bearing contacts the cam plate 1016, which causes the bearing and the moving support to rise, which causes the lead screw fixed to the moving support to pass through the rotating nut. Since the rotating nut is fixed in position, as the lead screw passes through the screw, the rotating nut is caused to rotate, which in turn rotates the part holder coupled to the rotating nut. The lead screw is described as being rotationally fixed to the moving support and the rotating nut free to rotate as a result of the relative linear motion between the screw and the nut, however, it is possible to allow the lead screw to rotate on the moving support 1012 and the nut rotationally fixed, in which case the relative linear movement between the lead screw and the fixed nut will cause the lead screw to rotate, which can be coupled to the parts holder.

The profile of the cam plate will cause the part to rotate as the bearing rises. Similarly, the part will rotate in the opposite direct as the bearing and moving support move downwards. The moving support and bearing may move downward, following the profile of the cam plate, under the force of gravity. However, gravity may not be sufficient, or the orientation may be such that gravity will not provide the required force, in which case a lowering force can be provided. For example, a spring may be secured to a fixed spring support 1030 attached to a lower support 1032 of the frame. A moving spring support 1034 may be secured to the moving support so that a spring connected between the two spring supports provides the lowering force to cause the moveable support and bearing to lower, following the came plate profile. Additionally, or alternatively, the bearing may contact an upper cam plate located above the bearing that forces the moveable support and bearing down as the shuttle moves along the track.

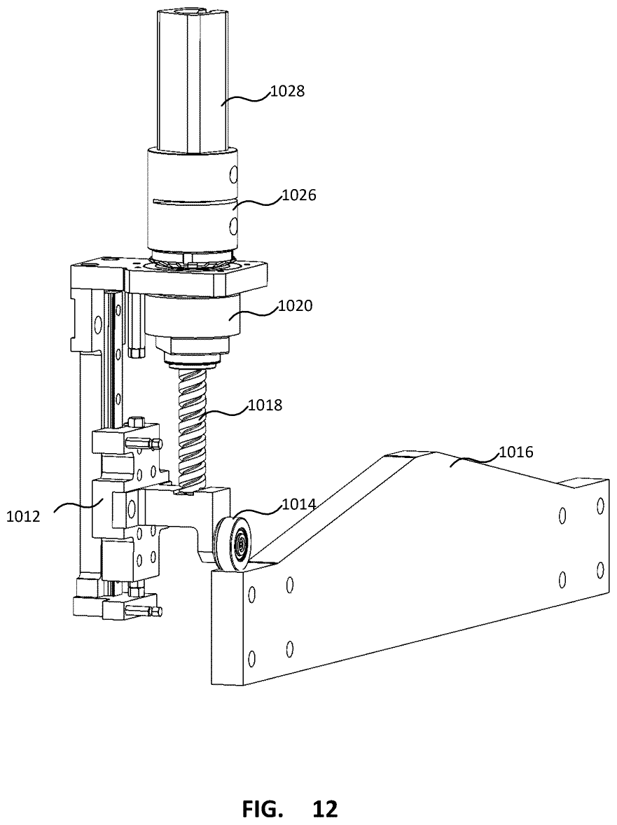

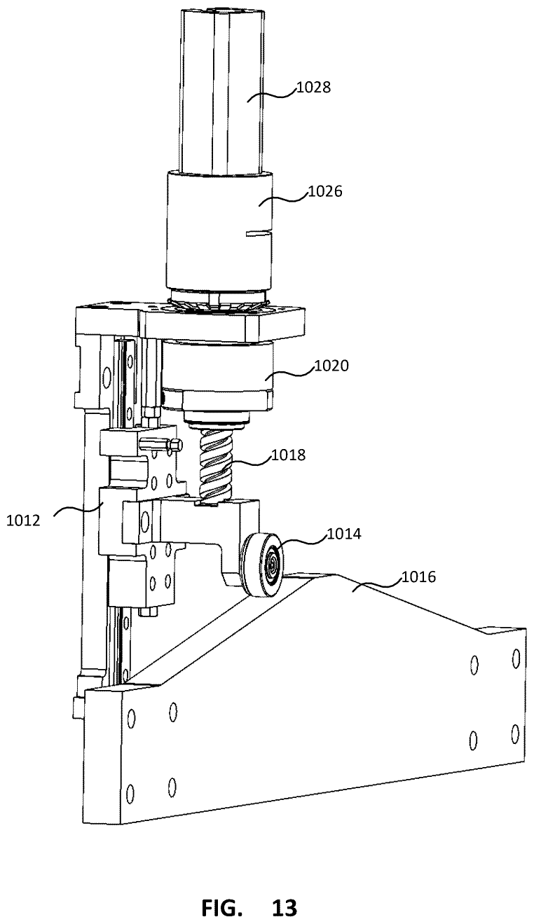

The operation of the mechanical rotation mechanism is depicted in FIGS. 12 and 13. FIG. 12 depicts the mechanism as the bearing 1014 first contacts the cam plate 1016. As the shuttle (not shown in FIGS. 12 and 13) continues to move along the track, the bearing follows the profile of the cam plate 1016, which as depicted rises before falling back down. As can be seen in FIG. 13, as the bearing rides along the cam plate, it is forced to rise, following the cam plate. Since the bearing is fixed to the moveable support 1012, it also rises, following the cam plate profile. The upper movement of the moveable support causes a lead screw to pass through a nut. One of the nut and the screw is fixed rotationally while the other is allowed to freely rotate. As such, the relative linear movement between the screw and nut translates the linear motion to rotational motion which is coupled to the parts holder. The lead screw is depicted as being mounted to the moveable support, and the rotating nut secured to the frame, however it is possible for the nut to be fixed to the moveable support and the lead screw fixed to the frame in a manner that allows rotation of the screw but not linear movement.

As can be seen in FIG. 13, as the bearing rides up the stationary cam plate 1016, the lead screw 1018 passes through the rotating nut 1020, causing it to rotate, which in turn causes the coupler 1026 and the parts holder 1028 to rotate. The rotation of the part in the part holder is determined by the profile of the cam plate and pitch of the screw and nut. For the same pitch of screw and nut, increasing the steepness of the cam plate will cause the part to rotate faster. Further, it will be appreciated that the rotational orientation of the parts holder is determined by the location of the bearing on the cam plate. Accordingly, the speed of rotation of the parts holder is matched to the speed of the shuttle. As the shuttle moves quicker over the cam plate, the part will rotate faster.

FIGS. 10-13 have depicted a relatively simple profile of the cam plate in which it rises, and the lowers, causing the part to rotate in a first direction and then back in the other direction. The profile of the cam plate may have one or more rising sections, which may rise at the same or different rates, one or more flat sections, and one or more descending sections, which may descend at the same or different rates. Further, the rising and falling, or descending, rates may be constant for a particular section or may vary within the section.

While the above has been described with particular reference to the labelling of objects using a shuttle moving on a linear motor conveyor system, it will be appreciated that other types of conveyor systems may be used, including for example chain driven conveyor systems, belt driven conveyor systems or other types of conveyors. Regardless of the type of motive force used to move the shuttles, the shuttles may have a power source, which may use a wireless power transfer system or an on-shuttle battery in order to provide power to the motor or motors on the shuttle used to rotate the objects for labelling.

It will be appreciated by one of ordinary skill in the art that the system and components shown in FIGS. 1-13 may include components and/or steps not shown in the drawings. For simplicity and clarity of the illustration, elements in the figures are not necessarily to scale, are only schematic and are non-limiting of the elements structures. It will be apparent to persons skilled in the art that a number of variations and modifications can be made without departing from the scope of the invention as defined in the claims.

Although certain components and steps have been described, it is contemplated that individually described components, as well as steps, may be combined together into fewer components or steps or the steps may be performed sequentially, non-sequentially or concurrently. Further, although described above as occurring in a particular order, one of ordinary skill in the art having regard to the current teachings will appreciate that the particular order of certain steps relative to other steps may be changed. Similarly, individual components or steps may be provided by a plurality of components or steps. One of ordinary skill in the art having regard to the current teachings will appreciate that the components and processes described herein may be provided by various combinations of software, firmware and/or hardware, other than the specific implementations described herein as illustrative examples.

The techniques of various embodiments may be implemented using software, hardware and/or a combination of software and hardware. Various embodiments are directed to apparatus, e.g. a node which may be used in a communications system or data storage system. Various embodiments are also directed to non-transitory machine, e.g., computer, readable medium, e.g., ROM, RAM, CDs, hard discs, etc., which include machine readable instructions for controlling a machine, e.g., processor to implement one, more or all of the steps of the described method or methods.

Some embodiments are directed to a computer program product comprising a computer-readable medium comprising code for causing a computer, or multiple computers, to implement various functions, steps, acts and/or operations, e.g. one or more or all of the steps described above. Depending on the embodiment, the computer program product can, and sometimes does, include different code for each step to be performed. Thus, the computer program product may, and sometimes does, include code for each individual step of a method, e.g., a method of operating a communications device, e.g., a wireless terminal or node. The code may be in the form of machine, e.g., computer, executable instructions stored on a computer-readable medium such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the method(s) described herein. The processor may be for use in, e.g., a communications device or other device described in the present application.

Numerous additional variations on the methods and apparatus of the various embodiments described above will be apparent to those skilled in the art in view of the above description. Such variations are to be considered within the scope of the current disclosure.

What is claimed is:

1. A system for applying a label to an object, the system comprising:
a conveyor system comprising a shuttle controllably moveable along a track, the shuttle comprising:
a mount for holding an object to have the label applied to, the object having a longitudinal axis; and
a rotation mechanism for rotating the object around the longitudinal axis;
a label dispenser arranged adjacent the track in order to affix a first portion of a label dispensed onto the object on the shuttle; and
an applicator arranged opposite a surface of the object having the label affixed to, the applicator contacting the label as the object is rotated in order to affix the label to the surface of the object.

2. The system of claim 1, wherein the applicator is moveable to match a speed of the shuttle or a speed of the object at a contact location between the object and the applicator.

3. The system of claim 1, wherein the object has an asymmetric cross section about the longitudinal axis.

4. The system of claim 1, wherein the applicator comprises a tamping pad that is mounted to an actuator that moves the tamping pad parallel to the shuttle and matching the shuttle speed while contacting the label being applied to object in an application zone.

5. The system of claim 1, wherein the applicator comprises a rotating belt.

6. The system of claim 5, wherein the rotating belt is mounted to an actuator that moves the rotating belt parallel to the shuttle matching a shuttle speed while contacting the label being applied to object in an application zone.

7. The system of claim 5, wherein the rotating belt rotates at a speed to account for one or more of:
the rotation of the object; and
the shuttle speed.

8. The system of claim 1, wherein the actuator can be moved towards and away from the surface of the object to account for the asymmetric cross-section of the object as it is rotated.

9. The system of claim 1, wherein a speed of the rotating belt is adjustable.

10. The system of claim 1, wherein the shuttle holds a plurality of objects, wherein a spacing between the plurality of objects on the shuttle allows respective objects to rotate a sufficient amount such that a surface of a subsequent object to contact the rotating belt is an equal distance from the rotating belt as a surface of the preceding object.

11. The system of claim 1, wherein the applicator is mounted on the shuttle.

12. The system of claim 11, wherein the applicator is moveable to allow loading and unloading of the object to be labelled from the mount.

13. The system of claim 11, wherein the applicator comprises a roller.

14. The system of claim 1, wherein the rotation mechanism comprises:
a motor for rotating the object around the longitudinal axis; and
a power source for operating the motor.

15. The system of any claim 14, wherein the mount holds a plurality of objects to be labeled.

16. The system of claim 15, further comprising one or more of:
a plurality of motors, each for rotating a respective one of the plurality of objects.

17. The system of claim 16, further comprising a drive train for rotating the plurality of objects with the motor.

18. The system of claim 1, wherein the rotation mechanism comprises a mechanical rotation mechanism.

19. The system of claim 18, wherein the mechanical rotation mechanism comprises:
a movable support coupled to the shuttle, the movable support comprising:
a bearing secured to the moveable support in a fixed relative position; and
a screw and nut arranged to translate relative linear movement between the screw and nut into rotational movement of the mount,
wherein the system further comprises:
a cam plate having a profile that the bearing contacts and causes relative linear movement between the screw and nut as the shuttle moves along the track.

20. The system of claim 19, wherein the screw is rotationally fixed to the moveable support and the nut is free to rotate.
